(19) United States
(12) Patent Application Publication
(10) Pub. No.: US 2022/0134142 A1
(43) Pub. Date: May 5, 2022

(54) PROTECTIVE GARMENT

(71) Applicant: RPB Safety, LLC, Royal Oak, MI (US)

(72) Inventors: Alan J. Gerrard, Christchurch (NZ); Patrick Bruyn, Christchurch (NZ); Garth Ivory, Bloomfield Hills, MI (US)

(21) Appl. No.: 17/515,336

(22) Filed: Oct. 29, 2021

Related U.S. Application Data
(60) Provisional application No. 63/111,615, filed on Nov. 9, 2020.
(60) Provisional application No. 63/110,337, filed on Nov. 5, 2020.
(60) Provisional application No. 63/108,283, filed on Oct. 30, 2020.

(51) Int. Cl. A62B 23/02; A41D 13/11

(52) U.S. Cl. CPC A62B 23/02; A41D 13/11

(57) ABSTRACT

A protective garment having a face shield frame with a first opening. A face shield is mounted to the frame covering this first opening. A hood is provided that has a second opening. The second opening has a perimeter edge. The face shield frame has a groove adjacent the first opening, and the edge is releasably secured within the groove. The edge is frictionally retained within the groove. Alternatively, the face shield frame can have a connecting frame that is inserted into a groove on the hood. The protective garment can also include filter opening with a removeable filter material juxtaposed over the filter opening.

### CROSS-REFERENCE TO RELATED APPLICATIONS

This application claims the benefit of U.S. Provisional Application Ser. No. 63/108,283 filed Oct. 30, 2020, U.S. Provisional Ser. No. 63/110,337 filed Nov. 5, 2020, and U.S. Provisional Application Ser. No. 63/111,615 filed Nov. 9, 2020, all of which are incorporated herein by reference in their entirety.

### STATEMENT REGARDING FEDERALLY SPONSORED RESEARCH

NONE.

### TECHNICAL FIELD

This invention relates generally to protective garments and more specifically to the attachment of protective capes or hoods to protective head or face coverings. Also to a vent system that can include a filter to filter inhaled and exhaled air.

### BACKGROUND OF THE INVENTION

Face shields, head gear, helmets, hoods and capes are common in the medical, pharmaceutical and industrial fields to provide a layer of protection to users in difficult environments. These devices can also include a PAPR to provide filtered air to the user and positive pressure within the covering around the user's face.

For example, the applicant's T-link has a face shield and a padded headliner and head suspension system, relieving the user of aches and strains on their neck and shoulders through its even weight distribution. A hood can be attached to the suspension system as well. The head suspension system has a fully adjustable ratchet system that ensures a personalized and secure fit for all head types maximizing stability and enabling the respirator to move with user's head. Utilizing these innovative design features ensures an unrestricted range of movement combined with unrivalled comfort, so the user can focus on the job at hand.

The face shield and padded headliner are multiuse products. The hood in many applications is not. It is intended to be disposable or replaceable after a period of use. A problem with the hoods or garments is that they are difficult to attach to the head gear, helmets, or face shields. What is needed is an easy and quick way to attach and remove hoods and other protective garments that are intuitive for the user.

Protective garments are typically made of wipeable material such as plastic, since they are often wiped down many times per day. Because plastic doesn't breathe, a vent is required to let air out of the cape. The problem with vented garments is the exhaled air can affect adjacent people due to exhaled aerosols etc. What is needed is a simple, inexpensive, effective filtration system.

What is needed is a better attachment system for attaching a hood to a face shield that is easy and intuitive and a way to easily replace the filter after use.

### SUMMARY OF THE INVENTION

A protective garment having a face shield frame with a first opening. A face shield is mounted to the frame covering this first opening. A hood is provided that has a second opening. The second opening has a perimeter edge. The face shield frame has a groove adjacent the first opening, and the edge is releasably secured within the groove. The edge is frictionally retained within the groove. In this way, the hood is attached to the face shield frame.

In one embodiment, the perimeter edge has a hem to frictionally fit within the groove. This hem can also contain an elastic member, such as elastic tubing or an elastic band that further secures the hem into the groove. A starting tab or tabs can also be provided on the hood and the face shield frame to facilitate the insertion of the perimeter edge into the groove. Alternatively, the perimeter edge can be elastic obviating the need for a hem.

In a still further embodiment, the perimeter edge has a groove positioned adjacent the second opening. The face shield frame includes a connecting frame that can be inserted into the perimeter edge groove. This connecting frame is releasably secured within the groove. The connecting frame of this embodiment can include first fasteners and the face shield frame can include second fasteners. The first and second fasteners mate to secure the hood to the face shield frame. For even better connection the first fasteners can extend through the hood to further secure the hood to the face shield frame.

The protective garment can also include a filter opening with a removeable filter material juxtaposed over the filter opening.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the protective garment of the present invention.

FIG. 2 is a perspective view of a powered air purifying respirator.

FIG. 3 is a perspective view of a face shield.

FIG. 4 is a cross section taken along line AA of FIG. 5.

FIG. 5 is a partial side view of the protective garment.

FIG. 6 is a perspective view of the second embodiment of the protective garment.

FIG. 7 is a side view of a hood.

FIG. 8 is a side view of the hood and face shield with the hood partially attached.

FIG. 9 is a front perspective view of the hood and face shield attached.

FIG. 10 is a side view of the shield of the present invention.

FIG. 11 is a partial front view of the shield of the present invention.

FIG. 12 is a side view of a hood with a face shield and the exhalation filter of the present invention.

FIG. 13 is a partial view of the cape showing the vent.

FIG. 14 is a partial view of the interior of the cape showing the vent pocket.

### DETAILED DESCRIPTION OF A PREFERRED EMBODIMENT

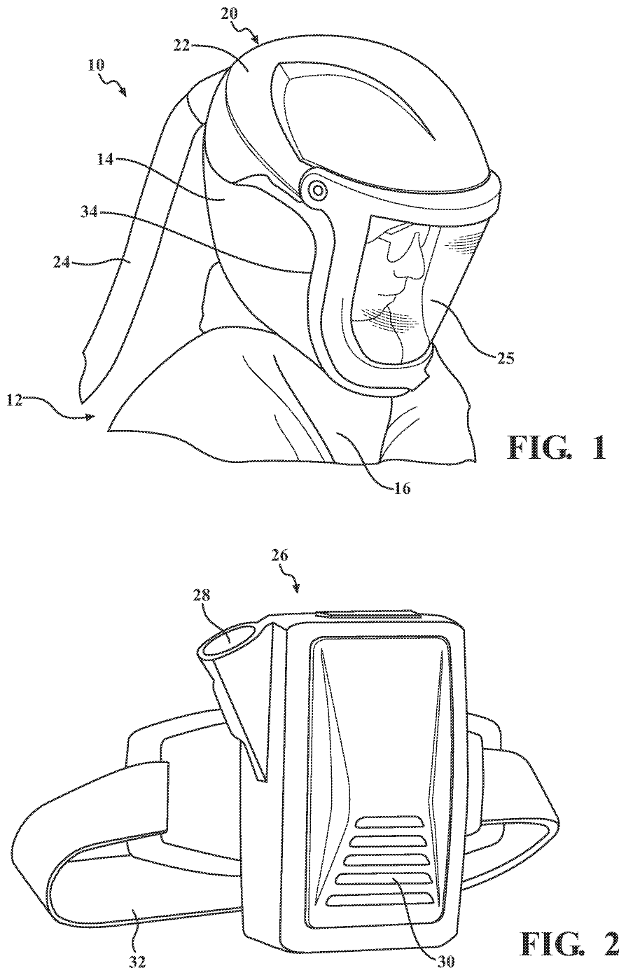

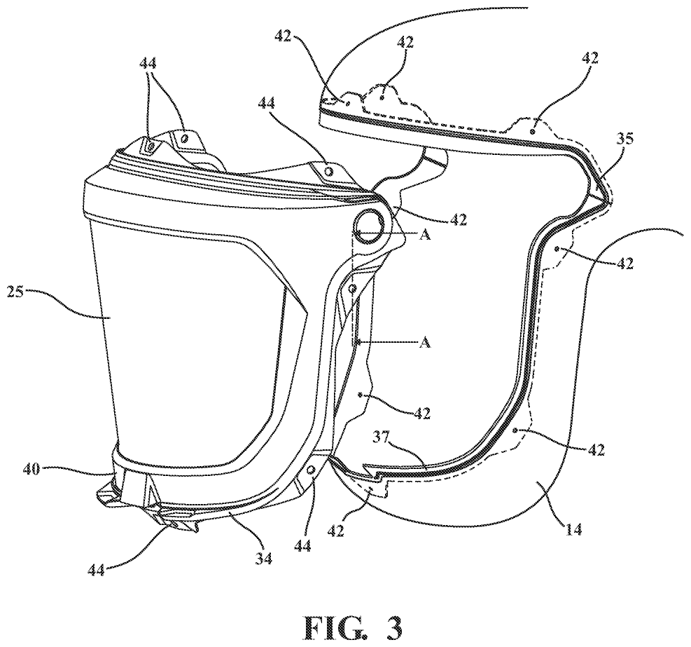

With reference to FIG. 1, an example of a protective garment is generally shown at 10. The garment 10 includes a garment or cape 12 which includes a hood 14 and gown 16. The hood 14 and gown 16 could be attached or separate articles depending upon the desired arrangement. Additionally, depending upon the use and environmental conditions, only the hood 14 can be used as illustrated in FIG. 3.

A face shield unit 20 is illustrated is illustrated in FIG. 1. The unit 20 has a helmet 22 with an attached face shield 25. The illustrated unit 20 has an air tube 24 attached between the unit 20 and a powered air purifying respirator 26 or a supplied air connection. An example is of a powered air purifying respirator is applicant's PX5.

The powered air purifying respirator 26 has an air outlet 28 to which the tube 24 connects. Air is drawn into the respirator 26 through the inlet 30, through interior filters, and then supplied to the air tube 24 for supply to the hood 14 or helmet 22. The respirator 26 is lightweight and is attached with a belt 32 around the waist of a user or can be attached as a backpack.

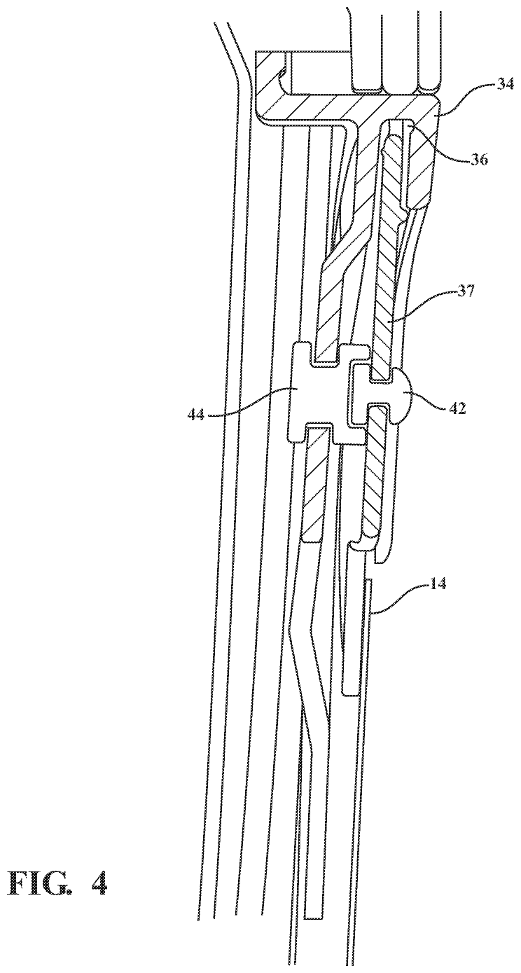

In use, the hood 14 and gown 16 are disposable, single use or multiple use garments. The helmet and face shield unit 20 is multiple use. When the user puts on the hood 14, it must be attached to the helmet 22 or the face shield 25 as shown in FIGS. 1 and 3 through 5. It should be understood that there are many different varieties of face shields 25 and helmets 22. Those illustrated are examples only for the purpose of describing the attachment system of the present invention.

The protective garment illustrated is only an example of the type of shield and hood of the present invention. Those of ordinary skill in the art will appreciate that the present invention will also work with a hood that covers the entire head and can be part of a garment that covers most or all a user's body or just a hood.

To make the attachment of the hood to the face shield more intuitive and easier, a connecting frame 34 is provided, see FIG. 3. The connecting frame 34 is in the shape of the outline of the face shield frame 40. Frame 34 is preferably made of plastic, but could be made of other lightweight materials, such as for example, rubber or stiffened paper or cardboard.

The hood 14 is attached around that frame 34. The hood 14 has a recess 35 that receives the frame 34. The recess can be a pocket formed in the hood 14 or can be an attachment that is attached to the hood 14. The attachment can be by sewing, welding of gluing for example.

The frame 34 and the recess 35 can be unitary or it can be split into several parts for easier manufacture, shipping & assembly.

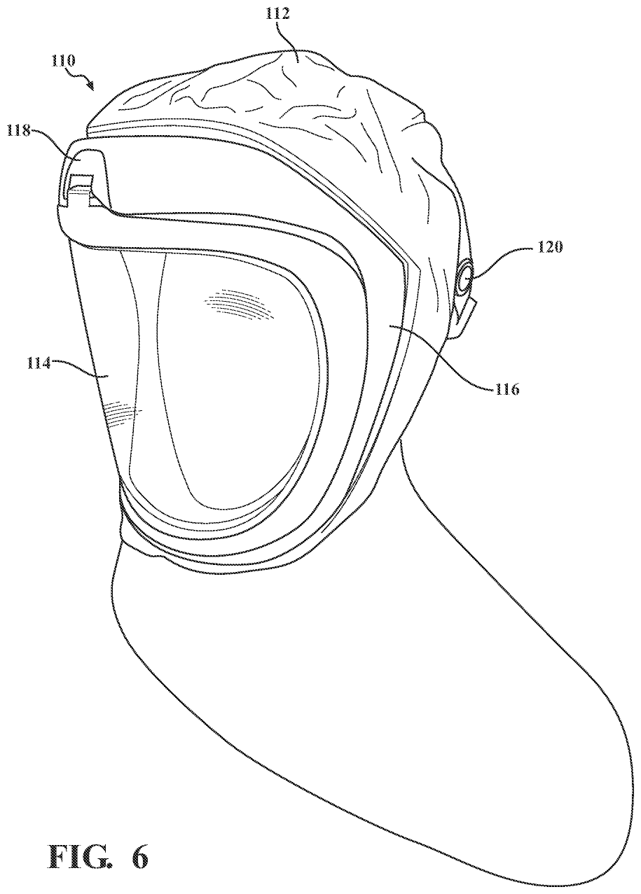

The frame 34 has the same shape as the opening in the hood 14. This makes attachment of the frame 34 to the hood 14 easily understandable and intuitive. With reference to FIG. 6, in one embodiment, the frame 34 has a channel 36 for receipt of the hood 14. The hood 14 can have a thicker portion 37 formed by sewing a cord and or plastic support into the edge of the hood 14 opening, folding over the opening and sewing it into a hem, etc. The channel 36 can also be formed to tightly capture the edge of the opening of the hood 14 and or being secured via a fastener.

To further secure the frame 34 on the hood 14 to the face shield 25, mating snaps 42 and 44 are provided. The snaps 42 and 44 are spaced about the frame 34 and the recess 35 as illustrated in FIG. 3. It should also be appreciated that other connectors could be used, such as for example Velcro® type hook and loop fasteners, double sided tape, pressure sensitive tape etc. The frame could also have indicia to assist in the proper alignment of the fasteners.

The frame 34 can be stamped or molded. The frame 34 can be integrally formed onto the frame 40 or it can be a separate piece or pieces to be assemble to the frame 40.

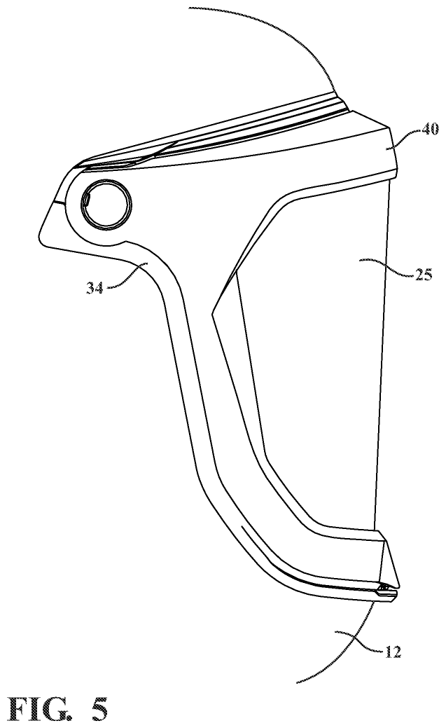

The cape attachment of the present invention is simple and quick. The attached cape looks sleek as the frame 34 is fully covered by hood 14, see FIG. 5. No complicated molded clips, screws etc. are necessary to ensure a secure attachment of the hood 14 to the frame 40.

To use, a person inserts the edge of the frame 34 into the recess 35 of the hood 14. The fasteners 42 and 44 can be attached. Once the fasteners are fastened, the cape is assembled. The shape of the frame 34 is the same shape as the face shield frame 40. In this way, proper alignment is intuitive. It can only be aligned one way and the complementary shapes guide that alignment. Additionally, the fasteners 42,44 also show proper alignment. The fasteners 42,44 also secure the frame 34 in proper position and help secure the hood 14 to the face shield frame 40.

With reference to FIGS. 6 through 11, a second embodiment of the present invention is shown at 110. In this embodiment, the shield 114 is mounted to the frame 116 by a pivot 118 that allows the shield to pivot up and down between open and closed positions. The frame 116 is attached to a head harness 120. As will be appreciated by those of ordinary skill in the art, the head harness 120 fits over the user's head to support the shield 114 and hood 112.

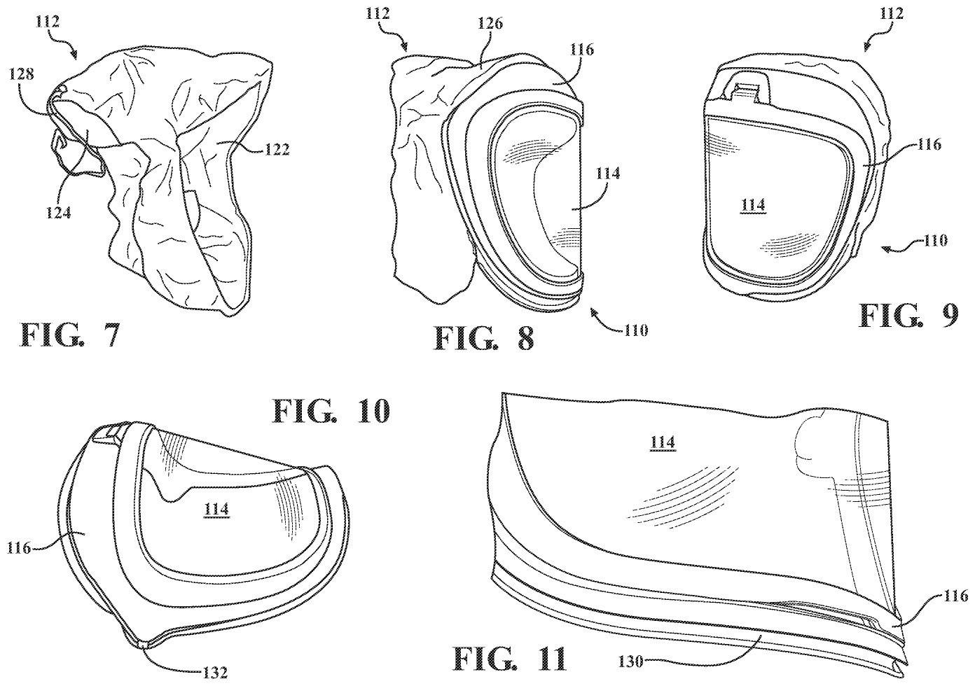

The hood 112 of the present invention is shown in FIG. 7. The hood 112 has a front opening 122 that surrounds the face shield 114 when attached and a rear opening 124 that fits over the user's head. The front opening has an elastic edge 126 around the perimeter of the opening 122. This can be an unbroken elastic edge 126 or it can be separate sections forming the elastic edge 126. In the disclosed embodiment, the elastic edge 126 is an elastic cord or band attached to the hood's edge 122. As illustrated, the rear opening 124 has a drawstring 128. This could alternatively be a simple ribbon or strap to be tied or incorporate a hook and loop feature, buttons, or hooks.

The hood 112 is secured to the face shield 114 by stretching the elastic edge 126 onto the frame 116. In FIG. 8, the hood 112 is partially attached and in FIG. 9 it is completely attached to the frame 116. Once on the frame, the elastic edge 126 is in constant tension thereby securing the hood 112 to the frame 116.

To facilitate the retention of the elastic edge 126, a channel 130 can be formed in the frame 116. The channel 130 extends about the perimeter of frame 116. Channel 130 is sized to tightly receive the elastic edge 126. In this way, there is positive engagement of the elastic edge 126 and the frame 116. This prevents the hood 112 from inadvertently being released from the frame 116. The elastic edge 126 is in constant tension once in the channel 130 and is being pulled into the channel 130 thereby securing the hood 112 to the frame 116.

With reference to FIG. 10, a starting tab 132 is provided on both sides of the frame 116. In the preferred embodiment, the elastic edge 126 would have a mating tab, or slot, or different color, or some other type of indicia to signal the proper positioning of that portion of the elastic edge 126 over the tab 132. The tabs 132 serves dual purpose. First, by initially fastening the elastic edge 126 of the hood 112 to the tabs 132, stretching the rest of the elastic edge 126 onto the frame 116 is made easier and faster. Also, the tabs 132 and mating indicia on the edge 126 make alignment faster and easier. The tabs 132 hold the elastic edge 126 initially and them allow it to be stretched and inserted into the channel 130.

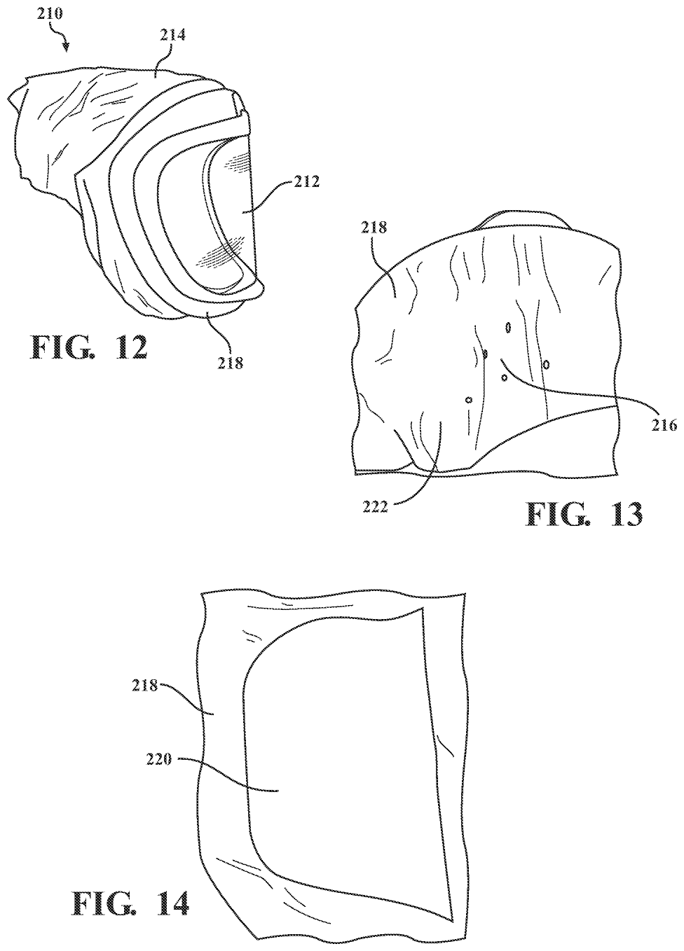

With reference to FIG. 12, a protective garment 210 is shown. The illustrated protective garment 210 includes a face shield 212 and a hood or cape 214 with and the exhalation filter of the present invention. It should be appreciated that the garment 210 is by way of example and other protective garments could be used, such as for example, hoods with helmets, PAPR systems, full body garments, etc.

With reference to FIG. 13, a vent 216 is provided in the lower portion 218 of the hood 214. The vent 216 is shown below the chin area of the user.

With reference to FIG. 14, a pocket 220 is provided on the inside of the cape 214. The pocket 220 is positioned over the vent 216 and receives a filter. The filter can be made of many different materials and can have several layers. One example of a filter material would be a HEPA filter. The pocket 220 could be an air permeable material, such as cotton cloth, or made of the same material as the wipeable cape 214 material with small holes 222 to allow air to pass through the material and the filter. If made of the same material, the filter pocket would be wipeable and the filter easily replaceable.

In other embodiments, the filter paper could also be attached to the cape 214 by an adhesive. Preferably, the adhesive would allow the filter to be easily removed for replacement and for the cape 214 to be wiped down. The filter could also be sewn into the cape 214.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A protective garment comprising:
a face shield frame having a first opening;
a face shield mounted to said face shield frame covering said first opening;
a hood having a second opening, said second opening having a perimeter edge;
said face shield frame having a groove adjacent said first opening, said edge being releasably secured within said groove;
whereby said hood is retained to said face shield frame.

2. The protective garment of claim 1, wherein said edge is frictionally retained within said groove.

3. The protective garment of claim 1, wherein said perimeter edge has a hem.

4. The protective garment of claim 3, wherein said hem contains an elastic member.

5. The protective garment of claim 1, wherein said perimeter edge includes at least one starting tab, and said face shield frame includes at least one mating tab;
wherein said at least one starting tab and said at least one mating tab can be juxtaposed to facilitate the insertion of said perimeter edge into said groove.

6. The protective garment of claim 1, wherein said perimeter edge is elastic.

7. A protective garment comprising:
a face shield frame having an outer perimeter and a first opening within said outer perimeter;
a face shield mounted to said face shield frame covering said first opening;
a connecting frame positioned at said outer perimeter;
a hood having a second opening, said second opening having a perimeter edge;
said perimeter edge having a groove for receipt of said connecting frame, said connecting frame being releasably securable within said groove;
whereby said hood is retained to said face shield frame.

8. The protective garment of claim 7, wherein said hood frame edge is releasably secured within said groove.

9. The protective garment of claim 8, wherein said connecting edge includes first fasteners and said face shield frame includes second fasteners, said first and second fasteners mating to secure said hood to said face shield frame.

10. The protective garment of claim 9, wherein said first fasteners extend through said hood to further secure said hood to said face shield frame.

11. The protective garment of claim 7, wherein said face shield frame is plastic.

12. The protective garment of claim 7, wherein said connecting frame edge is plastic.

13. A protective garment comprising:
a protective hood,
a face opening;
a filter opening;
a removeable filter material juxtaposed over said filter opening.

14. The protective garment of claim 13, wherein said filter opening includes a pocket for receipt of said filter.
